(19) United States
(12) Patent Application Publication
(10) Pub. No.: US 2015/0186841 A1
(43) Pub. Date: Jul. 2, 2015

(54) PROVIDING STEPS FOR A PRODUCT RETURN

(71) Applicant: Google Inc., Mountain View, CA (US)

(72) Inventors: Erwin Can Sar, Mountain View, CA (US); Timothy Youngjin Sohn, Mountain View, CA (US); Jackie Tsay, Mountain View, CA (US); Keith Coleman, Palo Alto, CA (US)

(73) Assignee: Google Inc., Mountain View, CA (US)

(21) Appl. No.: 14/144,880

(22) Filed: Dec. 31, 2013

(51) Int. Cl. G06Q 10/08; G06Q 30/00

(52) U.S. Cl. CPC G06Q 10/0837; G06Q 30/016

(57) ABSTRACT

Methods and apparatus related to generating steps to return a product and providing the steps to a user to enable the user to return the product. Product return indication data associated with a user may be received. A purchase source of the product may be determined. One or more sets of purchase source return steps for the purchase source may be retrieved from a mapping of multiple purchase sources to respective return steps. At least an attribute of the user and product data of the product may be identified. A set of steps to return the product may be generated based on the identified at least an attribute of the user and product data of the product. The set of steps to return the product may be provided to the user.

### BACKGROUND

A user may purchase a product and subsequently have a desire to return the purchased product. A user's desire to return the purchased product may be based on several factors such as discovering the product to be defective, discovering that the product is not fit for its purpose, and/or discovering that the product was incorrectly described at the time of purchase. For example, a user may purchase a table lamp, discover that the base of the table lamp is broken, and may wish to return the table lamp because it is defective. As another example, a user may purchase a pair of shoes, find that the pair is not comfortable, and wish to return the pair of shoes because the pair is not fit for its purpose.

### SUMMARY

The present disclosure is generally directed to methods and apparatus to generate steps to return a product. More particularly, the disclosure is directed to methods and apparatus to generate steps to return a product and provide the generated steps to a user to enable the user to return the product. The generated steps may be tailored to the user and/or a product to be returned based on one or more attributes of the user and/or based on one or more characteristics of the product. In some implementations, the attributes of the user and/or the characteristics of the product may be identified based on the product return indication data and/or additional data that is associated with the user. In some implementations, the providing of the generated steps to the user may be dependent on a determined product return indication score that is indicative of the strength of the desire of the user to return the product. In some implementations, the providing of the generated steps to the user may additionally and/or alternatively be dependent on a determined time period to return the product.

In some implementations, a method is provided and includes the steps of: receiving product return indication data associated with a user, the product return indication data indicating a desire of the user to return a product; determining, based on the product return indication data, a purchase source of the product; retrieving, from a mapping of multiple purchase sources to respective return steps, one or more purchase source return steps for the determined purchase source; identifying at least one of: an attribute of the user and product data of the product, the identifying based on one or more of the product return indication data and additional data associated with the user; generating a set of steps to return the product, wherein generating the set of steps is based on the purchase source return steps and based on at least one of: the attribute of the user and the product data of the product; and providing, to the user, the set of steps to return the product.

This method and other implementations of technology disclosed herein may each optionally include one or more of the following features.

The method may further include the step of determining a product return indication score based on the product return indication data, the product return indication score indicative of a strength of the desire of the user to return the product; and wherein the step of providing the set of steps to return the product may be dependent on the product return indication score. In some implementations, the product return indication data may include data related to one or more user actions that are associated with the product. The product return indication score may be based on the one or more user actions. In some of those implementations, the user actions may include one or more of a check-in of the user, a payment of the user, an electronic communication of the user, a search query of the user, and navigation to one or more documents by the user. In some implementations, a presentation prominence of the set of steps in providing the set of steps to return the product may be dependent on the product return indication score. In some implementations, the step of providing the set of steps to return the product may occur only when the product return indication score satisfies a threshold.

One or more of the retrieved purchase source return steps may be identified as customizable purchase source return steps and one or more of the purchase source return steps may be identified as fixed purchase source return steps; and wherein the step of generating the set of steps may be based on at least one of: the attribute of the user and the product data of the product, and generating the set of steps may be for only the purchase source return steps that are identified as customizable.

The step of generating the set of steps may include the step of determining a shipping service for one or more steps of the set of steps to return the product, wherein the step of determining the shipping service may based on the attribute of the user. The attribute of the user may include at least one of a geographic location of the user and a shipping preference of the user and the step of determining the shipping service may be based on at least one of the geographic location and the shipping preference.

The step of determining the set of steps may include the step of determining one or more shipping materials for one or more steps of the set of steps to return the product, wherein determining the shipping materials may be based on the product data of the product. The product data may include at least one category of the product and the step of determining the shipping material may be based on the at least one category of the product.

The method may further include the step of determining a time period for return of the product. A presentation prominence of the set of steps in providing the set of steps to return the product may be dependent on the time period for return of the product. The step of providing the set of steps to return the product may occur only when the time period for return of the product satisfies a threshold.

The step of determining the purchase source of the product may be further based on the product data of the product.

The step of generating the set of steps may be based on both the attribute of the user and the product data of the product.

The method may further include the step of: determining a quality measure for the set of steps to return the product, wherein the step of providing the set of steps occurs only when the quality measure satisfies a threshold.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein may determine a purchase source and/or purchase source return steps for a product to be returned. Particular implementations of the subject matter described herein may generate a set of steps to return the product and/or provide the set of steps to a user. The purchase source, purchase source return steps, and/or the set of steps to return the product may represent new information determined for the user and/or the product.

It should be appreciated that all combinations of the foregoing concepts and additional concepts described in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 is a block diagram of an example environment in which a set of steps to return a product may be generated and/or provided to the user.

FIG. 2 is an illustration of example associations between purchase sources and purchase source return steps in a database.

FIG. 3A is an illustration of generating an example set of steps based on a purchase source return steps.

FIG. 3B is another illustration of generating an example set of steps based on a purchase source return steps.

FIG. 4 is an example graphical user interface for providing a generated set of steps to return a product.

FIG. 5 is a flow chart illustrating an example method of generating a set of steps to return a product.

FIG. 6 illustrates a block diagram of an example computer system.

### DETAILED DESCRIPTION

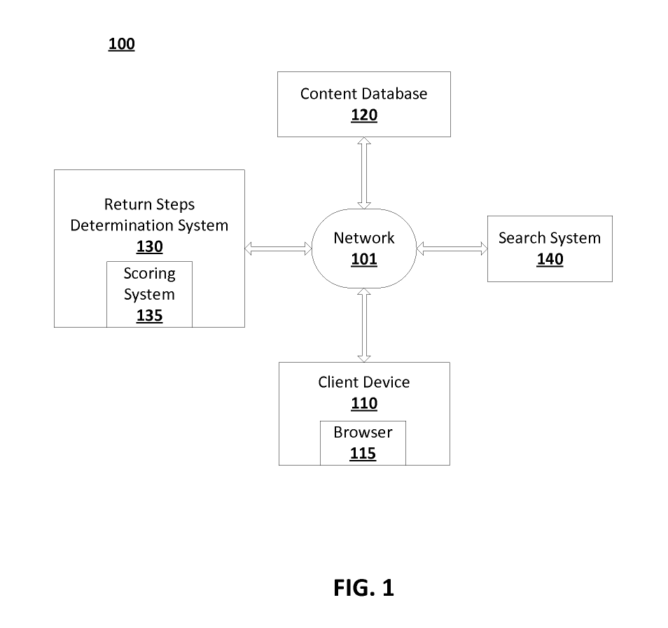

FIG. 1 illustrates a block diagram of an example environment 100 in which a set of steps to return a product may be generated and/or provided to a user. The example environment 100 includes a communication network 101 that facilitates communication between the various components in the environment. In some implementations the communication network 101 may include the Internet, one or more intranets, and/or one or more bus subsystems. The communication network 101 may optionally utilize one or more standard communications technologies, protocols, and/or inter-process communication techniques. The example environment 100 also includes a client device 110, a content database 120, a return steps determination system 130, a scoring system 135, and a search system 140. The client device 110 may execute one or more applications, such as a web browser 115.

In some implementations a user may interact with the return steps determination system 130 via at least one client device 110. The client device 110 may be, for example, a desktop computer, a laptop, a tablet computer, a mobile phone, a computing device of a vehicle of the user (e.g., an in-vehicle communications system, an in-vehicle entertainment system, an in-vehicle navigation system), a wearable apparatus of the user that includes a computing device (e.g., a watch of the user having a computing device, glasses of the user having a computing device). Additional and/or alternative computing devices of the user may be provided.

The client device 110, the return steps determination system 130, and the search system 140 may each include memory for storage of data and software applications, a processor for accessing data and executing applications, and components that facilitate communication over the communication network 101. The operations performed by the client device 110, the return steps determination system 130, and/or the search system 140 may be distributed across multiple computer systems. In some environments the return steps determination system 130 may include the scoring system 135. In some environments the return steps determination system 130 and the scoring system 135 may be separate components of the environment.

The return steps determination system 130 may receive a user identification identifying a user, and product return indication data that is associated with the user and that indicates a desire of the user to return a product. In some implementations the received user identification and/or the received product return indication data may be based on information provided from the client device 110 and/or one or more additional computing devices of the user.

The user identification identifies a user either specifically or generally. In some implementations the user identification may be provided with and/or included with a document identifier and/or content provided in response to one or more user actions via the client device 110 and/or other computing device. For example, as described herein, the user identification may be provided with and/or included with product return indication data provided in response to one or more user actions via the client device 110. For example, the user identification may be an IP address, a geographic region, and/or other information stored in a cookie that is submitted with and/or included with product return indication data provided by the client device 110. Also, for example, the user identification may be a user identification that is associated with a service that manages the return steps determination system 130 and/or that has partnered with a service managing the return steps determination system 130 and may be submitted to the return steps determination system 130 with product return indication data by the client device 110. For example, a user may, via client device 110, utilize user credentials to log in to a first service that manages the return steps determination system 130 and user identification data that is associated with the first service may be provided with the product return indication data generated via client device 110.

### Product Return Indication Data

The product return indication data is indicative of a desire of a user to return a product. The product return indication data may include data of a user that is related to the purchase of a product and/or data of the user that is related to post-purchase activities of the user. The product return indication data may be based on one or more actions of the user via the client device 110 and/or other computing device and/or based on locational data associated with the client device 110 and/or other computing device of the user.

In some implementations the product return indication data may be provided to the return steps determination system 130 directly from the client device 110. In some implementations the product return indication data may be provided to the return steps determination system via one or more alternative components such as, for example, the content database 120. For example, product return indication data for a user may be stored in one or more databases such as the content database 120 and retrieved from the one or more databases by the return steps determination system 130. Any stored product return indication data for a user may be stored in a manner that prevents access to other users besides the user and/or one or more users authorized by the user.

As one example, after purchasing a table lamp, the user may visit, via the client device 110, a web-based document that includes information related to product returns for the store where the table lamp was purchased. A document identifier of the web-based document (e.g., a uniform resource locator) may be product return indication data that is provided to the return steps determination system 130. The return steps determination system 130 may determine, based on the document identifier, that the user may have a desire to return the table lamp. For example, the return steps determination system 130 may access an index entry for the document identifier in an index to determine the document identifier is associated with return of a product. For example, the index entry may include information indicating the document is associated with return of a product and/or the index entry may include keywords associated with the document that may be determined to relate to return of a product.

As another example, after receiving a pair of shoes, the user may place a telephone call, via the client device 110, to the customer service department of the store from where the pair of shoes was purchased. The telephone number may be provided to the return steps determination system 130 by the client device 110. The return steps determination system 130 may access a database, such as content database 120, to determine an association between the telephone number called and one or more indications that the telephone number relates to a product return. For example, the database may include an association between the telephone number and data that explicitly identifies the telephone number as related to a product return. Also, for example, the database may include an association between the telephone number and the text “customer service department”, and the return steps determination system 130 may determine the telephone number is associated with product return based on the text “customer service department”.

As described herein, additional and/or alternative product return indication data may include data related to, for example, selections made by the user of search results provided by a search system, a search query issued by the user, a post by the user on a social networking platform, a locational query issued by the user, a location check-in by the user, an email communication of the user, and so on. As used herein, a “selection” of a search result, document, link, etc. may include, for example, a mouse click, a click-through, a voice-based selection, a selection by a user's finger on a presence-sensitive input mechanism (e.g., a touchscreen device), and/or any other appropriate selection mechanism. The term “check-in”, as used herein, includes a user-approved and/or user-initiated indication of a visit to a location.

As another example of product return indication data, the user may post a comment on a social networking platform that indicates a desire to return a product. For example, the user may post a comment stating: “These new shoes don't fit!”. The return steps determination system 130 may receive product return indication data related to the post and determine the post indicates a desire of the user to return the product. For example, the return steps determination system 130 may receive text of the post and determine a desire to return a product based at least in part on one or more terms of the post such as “new shoes” and “don't fit.” In some implementations, the return steps determination system 130 may identify one or more terms that are associated with a return desire (e.g., “don't fit”) and/or a product (e.g., “new shoes”) based on information in a database such as content database 120.

In some implementations the product return indication data may include navigation information that is provided to the return steps determination system 130. The navigation information may be indicative of a desire of the user to return a product. For example, the navigation information may include information related to one or more web-based documents visited by a user and/or one or more search queries issued by the user. For example, the user may access a first web-based document of an online retailer that provides information related to one or more items purchased by the user via the online retailer. The web browser 115 may provide content of the web-based document to the return steps determination system 130 such as, for example, information related to the one or more purchased items such as description, images, and/or price of a pair of shoes purchased by the user.

After receiving the pair of shoes, the user may issue a search query related to, and subsequently navigate to, a second web-based document that includes information related to product returns for the online retailer where the pair of shoes was purchased. The client device 110 may provide navigation information, such as a document identifier of the second web-based document and/or content of the second web-based document, to the return steps determination system 130. In some implementations the client device 110 and/or another component (e.g., a search system) may also provide, to the return steps determination system 130, information related to the search query issued in navigating to the second web-based document. Based at least in part on information related to the search query, the first web-based document, and/or the second web-based document (e.g., key terms, product return indicator associated with the second web-based document, product return indicator associated with the search query), the return steps determination system 130 may determine that navigation to the second web-based document by the user is indicative of a desire of the user to return the pair of shoes.

In some implementations the product return indication data may include a map-based locational query issued by the user. For example, a user may issue, via the client device 110, a directional locational query to a location and one or more mapping services may be utilized to return directions to the location. As another example, a user may issue a directional locational query to a location via a device equipped with GPS for turn-by-turn directions. In some implementations the return steps determination system 130 may access the content database 120 to determine an association between the location of the locational query and a product recently purchased by the user. For example, the content database 120 may store data related to the purchase of the product by the user, including a name of a purchase source of the product, an address associated with the purchase source, an address associated with a return location for products purchased at the purchase source, a telephone number associated with the purchase source, and so forth. The return steps determination system 130 may determine that the location of the locational query is related to the purchase source of the product and/or the return location for the product and, based on such determination, determine the locational query indicates a desire of the user to return the recently purchased product.

In some implementations the product return indication data may include data based on a search query of the user related to the product to be returned. For example, the user may submit a search query to the search system 140 from the via client device 110. The search query may be provided to the return steps determination system 130 (e.g., from the client device 110 or the search system 140) and the return steps determination system 130 may determine the search query indicates a desire to return a product. For example, the user may issue a search query related to how to return a table lamp, how to return a pair of shoes, how to return a pool table, and so forth. Based at least in part on key terms such as “return,” “table lamp,” “shoes,” and “pool table,” the return steps determination system 130 may determine the search query indicates a desire to return a product. In some implementations users may interact with the search system 140 through one or more client devices 110. The search system 140 may receive queries from one or more client devices 110 and may execute the queries against a database of available documents such as web pages, videos, images, text documents, and/or other content. The search system 140 may identify content which matches the queries, and may respond by generating search results that are provided to the one or more client devices 110 in a form that can be presented to the users.

Product return indication data based on multiple user actions and/or locational data may optionally be combined to determine a desire of a user to return a product. For example, electronic communications of a user (e.g., a purchase confirmation e-mail sent to the user) may indicate that the user may have purchased a product, and the user's navigation history may indicate that the user is seeking information related to returning the product. As another example, financial activity of the user may indicate that the user may have purchased a product and a post on a social networking site may indicate user's desire to return the product. As yet another example, a social networking post, navigation history, and a locational query may all indicate a desire of a user to return a product. A combination of one or more such user actions may indicate that user is seeking information related to returning the product. Based at least in part on product return indication data from such multiple user actions, the return steps determination system 130 may determine a desire of a user to return a product.

### Product Return Indication Score

In some implementations the scoring system 135 may determine a product return indication score based on the product return indication data received by the return steps determination system 130. The product return indication score is indicative of the strength of the desire of the user to return a product associated with the product return indication data. As described herein, the product return indication score may be utilized by the return steps determination system 130 to determine when and/or how to provide the user with generated steps to return the product. For example, the return steps determination system 130 may provide the steps to return the product only when the product return indication score satisfies a threshold. Also, for example, the manner in which return steps determination system 130 provides the set of steps to return the product may be dependent on the product return indication score.

For example, the user may purchase a product at a purchase location. Subsequently, the user may issue a directional locational query for turn-by-turn directions to the purchase location. Product return indication data related to the directional locational query may be received by the product return determination system 130. The scoring system 135 may determine a product return indication score based solely on the product return indication data related to the directional locational query. The determined product return indication score may be based on, for example, a product return value for the purchase location in a database such as content database 120. The product return value for the purchase location may not be indicative of a strong likelihood of product return since other non-return activities may be performed at the purchase location, such as a purchase of other products. The determined product return indication score may fail to satisfy a threshold score and, as a result, the product return determination system 130 may not provide steps to return the product based solely on the directional locational query.

However, if in addition to the directional locational query to the purchase location, the user places a telephone call to a phone number associated with returns to the purchase location, the scoring system 135 may determine a product return indication score based on product return indication data related to the directional locational query and the call to the phone number. The determined product return indication score may be based on, for example, product return values for the purchase location and for the phone number in a database such as content database 120. The product return value for the purchase location may not be indicative of a strong likelihood of product return, but the product return value for the phone number may be indicative of a strong likelihood of product return since the phone number is specifically associated with product returns. The determined product return indication score may be based on both product return values and may satisfy a threshold score based on the product return value for the phone number. As a result of the product return indication score satisfying the threshold score, the product return determination system 130 may provide steps to return the product based on the directional locational query and the call to the phone number.

As another example, product return indication data based on GPS or other locational data associated with a mobile device of a user may indicate that the user is at or near a purchase location. Additional product return indication data based on a purchase confirmation e-mail of the user may indicate that the user recently purchased a product at the purchase location. The scoring system 135 may determine a product return indication score based on the product return indication data related to the locational data and the purchase confirmation e-mail. The determined product return indication score may be based on, for example, the amount of time since the purchase date of the product as indicated by the purchase confirmation e-mail. The product return indication score may be indicative of a “medium” likelihood of product return if the amount of time since the purchase date of the product is relatively small. Based on the “medium” likelihood of product return, the product return determination system 130 may, in providing the set of steps to return the product, first provide an inquiry to the user as to whether the user would like to see the set of steps and, only provide the set of steps if the inquiry is responded to in the affirmative by the user.

However, if in addition to the product return indication data related to the locational data and the purchase confirmation e-mail, further product return indication data is received that is further indicative of a desire to return the product, the scoring system 135 may determine a product return indication score that is indicative of a “high” likelihood of product return. For example, additional product return indication data may include locational data at or near a return location in the purchase location and/or a message sent by the user (e.g., post to a social networking site, text message) that may state, for example, that “these return lines are long.” A new product return indication score may be determined that is based on such additional product return indication data. The new product return indication score may be indicative of a “high” likelihood of product return. Based on the “high” likelihood of product return, the product return determination system 130 may, in providing the set of steps to return the product, provide the set of steps in a notification without first providing an inquiry to the user as to whether the user would like to see the set of steps.

As another example, product return indication data may be based on a search query of “how do I return a television to Store X”. The scoring system 135 may determine a product return indication score for the query based on one or more terms of the search query. For example, the scoring system 135 may determine the search query includes one or more inquiry terms (“how do I”), one or more terms that indicate a return intent (“return”), one or more terms that identify a product (“television”), and one or more terms that indicate a purchase source of the product (“Store X”). The scoring system 135 may determine a product return indication score that is indicative of a “high” likelihood of product return based on the presence of the inquiry terms, the term that indicates a return intent, the term that identifies the product, and the terms that identify the purchase source. In some implementations the scoring system 135 may utilize a database such as content database 120 that includes data that enables identification of terms as inquiry terms, return intent terms, product terms, and/or purchase source terms. For example, the database may include identifications of inquiry terms (e.g., “how”, “what”, “where”), return intent terms (e.g., “return”, “refund”, “return policy”), product terms (e.g., product categories, product descriptions, brands of products), and/or purchase source terms (e.g., store categories, store names, store descriptions).

As another example, the scoring system 135 may determine a product return indication score that is less indicative of likelihood of product return (e.g., a “medium” likelihood) based on a query that includes an inquiry term and a return intent term, but does not include a term that identifies a product or a term that identifies a purchase source. As another example, the scoring system 135 may determine a product return indication score that is less indicative of likelihood of product return (e.g., a “low” likelihood) based on a query that includes a term that identifies a product, but does not include an inquiry term, a return intent term, or a term that identifies a purchase source. As described herein, the product return indication score may be utilized by the return steps determination system 130 to determine when and/or how to provide the user with generated steps to return the product.

In some implementations the product return indication data may include a plurality of queries, such as sequentially submitted queries, and the product return indication score may be based on the plurality of queries. For example, a first query that includes a product return indication term but does not include an inquiry term may not be identified as a query indicating a desire to return a product and may be associated with a product return indication score that does not satisfy a threshold product return indication score. However, the user may submit a subsequent query that includes a product return indication term that is similar to the product return indication term of the first query (optionally in combination with an inquiry term). The product return indication score for the subsequent query may take into account the first query and may satisfy the threshold product return indication score. In some implementations the subsequent query immediately follows the first query.

As described herein, in some implementations the product return indication score may be determined based on product return indication data from multiple user actions and/or locational data that may optionally be combined to determine a product return indication score. For example, standing alone, a query of a user that includes one or more return intent terms, but does not include an inquiry term may be associated with a product return indication score that fails to satisfy a threshold product return indication score. However, additional product return indication data related to one or more additional user actions (e.g., based on purchase history, an email, and/or a post on a social media platform) may indicate that the user is likely to return a product. The product return indication score may be adjusted based on such additional product return indication data to be more likely to satisfy a threshold product return indication score. In some implementations certain types of product return indication data may be weighted more heavily in determining a product return indication score. For example, search queries, posts, or other content inputted by a user may be weighted more heavily than locational data indicating a current or past location of a user. Also, for example more recent in time product return indication data may be weighted more heavily in determining a product return indication score than less recent in time product return indication data.

Product return indication data may be utilized by the return steps determination system 130 to determine product data of a product to be returned, determine a purchase source associated with the product return indication data, determine purchase source return steps for the purchase source, and/or to generate a set of steps to return the product.

In some implementations the return steps determination system 130 may determine product data based on the product return indication data and/or additional data associated with a user. Product data identifies one or more characteristics of one or more products associated with the product return indication data. Product data for a product may include, for example, one or more of: an alias of the product; a brand of the product; a coded identifier of the product (e.g., a barcode, a serial number, a product code, an inventory code); a type of the product (e.g., glassware, electronics, laptop, perishable, fragile, high value, clothing, book, and/or toy); weight information of the product (e.g., a specific weight, a weight range (e.g., 5-10 lbs.), a weight category (e.g., light, medium, heavy)); and/or dimension information of the product (e.g., a specific dimension, a dimension range, a dimension category).

In some implementations the return steps determination system 130 may determine some or all aspects of the product data based on the product return indication data. For example, the product return indication data may include data based on an e-mail to the user from Retailer 1 confirming the purchase of a television from Retailer 1 and data based on a query of “how do I return my purchase from Retailer 1”. Based on an association of the query with Retailer 1 and an association of the e-mail with Retailer 1, the return steps determination system 130 may determine product information in the e-mail from Retailer 1 may be utilized as product data. For example, the e-mail may include terms identifying an alias of the television (e.g., “60 inch LED HD TV”), a brand identifier of the product (e.g., “Brand X”), a product code of the product (e.g., model “LED60ABC”), and weight and dimension information of the product. In some implementations one or more natural language processing techniques may optionally be utilized to determine such product data from the e-mail. In some implementations conformance of the e-mail to a known format may additionally and/or alternatively be utilized to determine such product data from the e-mail. For example, it may be known that e-mails from Retailer 1 include the model number in parentheses in the subject line of the e-mail.

In some implementations the return steps determination system 130 may determine some or all aspects of the product data based on the product return indication data, but not directly from the product return indication data. For example, in the preceding example the e-mail may include price information for the television and the return steps determination system 130 may utilize the price information to determine if the television is a high value product.

In some implementations, the return steps determination system 130 may utilize one or more databases that are not personal to the user in determining one or more aspects of product return indication data. For example, an entity database may be utilized. An entity database may include, for each of a plurality of entities, a mapping (e.g., data defining an association) between the entity and one or more characteristics of the entity and/or other entities related to the entity. In some implementations, entities are topics of discourse. In some implementations, entities are persons, places, concepts, and/or things that can be referred to by a textual representation (e.g., a term or phrase) and are distinguishable from one another (e.g., based on context).

For example, product return indication data may include data based on a query of “how do I return my LED60ABC television to Retailer 1”. The term “LED60ABC” may be a model number that is mapped to an entity associated with a particular LED television in the entity database. Other entities and/or characteristics that are mapped to the entity associated with the particular LED television in the entity database may be determined and utilized as product return indication data. For example, the entity associated with the particular LED television may be mapped to an entity associated with a particular brand and that brand may be utilized as product data. Also, for example, the entity associated with the particular LED television may be mapped to weight and dimension characteristics and those characteristics may be utilized as product data. Also, for example, the entity associated with the particular LED television may be mapped to entities associated with types of products to which the entity associated with the particular LED television belongs (e.g. “televisions”, “LED televisions”, “electronics”) and one or more of those types of products may be utilized as product data.

Other product return indication data that is associated with the purchase of a product by a user may be utilized to identify product data. For example, data may be associated with the user in one or more databases that are personal to the user that associate information related to past purchases of the user with the user. Associated information related to past purchases of a product by the user may include one or more of a product, a brand, a model number, a serial number, a product barcode, price related information (e.g., purchase price, listed price, manufacturer's suggested retail price, discount information), year of manufacture, an expiry date, and a purchase date.

Also for example, product return indication data that is associated with the purchase of a product by a user may include document identifiers of one or more web-based documents with which the user interacted to purchase the product. The return steps determination system 130 may determine product data based on content of the web-based documents (e.g., by accessing the documents to identify one or more product data terms in the documents). As another example, product return indication data that is associated with the purchase of a product may include a post related to the purchase, an email confirmation of the purchase, a text related to the purchase, and so forth. For example, an e-mail of the user may confirm purchase of the product and data of the e-mail may be utilized to determine the purchase date of the product. The return steps determination system 130 may extract a purchase date for the product from the email using, for example, one or more language processing techniques. Also, for example, a user may create a calendar entry that identifies an upcoming purchase that may be utilized to determine the purchase date of the product. Also, for example, a user may create a post, upload images, and/or perform other actions via a social networking application that may be utilized to determine the purchase date of the product.

As another example, a user may initiate and/or complete a financial transaction that may be utilized to determine the purchase date of the product. For example, data associated with the user may be accessed to determine the mode of payment for a product at the time of purchase, the price paid for the product, the purchase date of the product, and so forth.

### Purchase Source of a Product

In some implementations the return steps determination system 130 may determine the purchase source of the product based on the product return indication data and/or additional data associated with a user. A purchase source may be a manufacturer, a retailer, a brick and mortar location, an online store, an individual, and so forth. In some implementations, the determined purchase source may be a source that has multiple venues for purchasing the product. For example, the determined purchase source may be a brick and mortar retail chain that has multiple individual stores in which the product may have been purchased and/or one or more online stores from which the product may have been purchased. Also, for example, the determined purchase source may be an online retailer that has multiple affiliated websites from which the product may have been purchased. In some implementations the determined purchase source may be a particular venue. For example, the determined purchase source may be an individual store of a brick and mortar retail chain.

In some implementations the return steps determination system 130 may determine the purchase source based on the product return indication data. For example, the product return indication data may include data based on a web-based document visited by the user that includes information related to product returns for an online store where a table lamp was purchased. The purchase source may be determined to be the online store associated with the web-based document visited by the user. The return steps determination system 130 may determine the online store is associated with the web-based document based on, for example, one or more language processing techniques (e.g., parsing the URL to extract the name of the online store) and/or an index entry for the web-based document that associates the web-based document with the online store. As another example, the product return indication data may include data based on a query of “how do I return my purchase from Retailer 1”. Based on an association of the query with Retailer 1, the return steps determination system 130 may determine Retailer 1 to be the purchase source.

As another example, the product return indication data may include data based on an e-mail confirming a previous purchase of the user of a phone from Retailer 1 and data based on a query of “how do I return the phone I purchased”. Based on an association of the query with the phone and an association of the e-mail with the phone, the return steps determination system 130 may utilize the “Retailer 1” in the e-mail as the purchase source. As another example, a user may create a calendar entry that identifies an upcoming purchase and a purchase location that may be utilized to determine the purchase location of the product. As another example, a user may create a post, upload images, and/or perform other actions via a social networking application that may be utilized to determine the purchase location of the product. As another example, a user may initiate and/or complete a financial transaction that may be utilized to determine the purchase location of the product.

In some implementations the return steps determination system 130 may determine the purchase source based on the product return indication data, but not directly from the product return indication data. For example, in some implementations the return steps determination system 130 may utilize one or more databases that are not personal to the user in determining the purchase source. For example, the product return indication data may include data based on a telephone call made by the user, via a mobile computing device, to the customer service department of a store from where a pair of shoes was purchased. The return steps determination system 130 may identify the telephone number as being associated with the customer service department of the store based on an association between the telephone number and the store in one or more databases such as an entity database. As another example, the product return indication data may include data based on a post related to a product purchase and data based on a location of the user when the post was made. For example, the user may be at the purchase location and a post concerning the purchase of the product while at the purchase location. The return steps determination system 130 may determine the location of the post maps to a purchase source in one or more databases and utilize the mapped purchase source as the determined purchase source.

### Purchase Source Return Steps

The return steps determination system 130 may retrieve one or more purchase source return steps of the determined purchase source. The one or more purchase source return steps may be retrieved from a mapping of multiple purchase sources to respective return steps. For example, the content database 120 may include identifiers of multiple purchase sources and, for each purchase source, one or more purchase source return steps. As one example, the return steps determination system 130 may determine the purchase source as Online Store Y and the content database 120 may include data associating an identifier of Online Store Y with one or more purchase source return steps. The return steps determination system 130 may access the content database 120 and retrieve the one or more purchase source return steps.

In some implementations the retrieved purchase source return steps for a purchase may be a subset of all the purchase source return steps associated with the purchase source. For example, in some implementations the purchase source may have a first set of purchase source return steps that is associated with returns of products of a product type of “electronics” and a second set of purchase source return steps that is associated with all other returns. Based on determined product return indication data that indicates the product is of a product type of “electronics”, the product return steps determination system 130 may retrieve only the first set of purchase source return steps.

In some implementations the return steps determination system 130 and/or other component may create the mapping of multiple purchase sources to respective return steps. For example, for a given purchase source the return steps determination system 130 may identify a return policy and generate the one or more purchase source return steps based on the return policy. In some implementations the return steps determination system 130 may crawl the World Wide Web or other resource to extract information related to the return steps of a purchase source and utilize such extracted information to generate the return steps for the purchase source. For example, the return steps determination system 130 may crawl one or more web-based documents related to a purchase source to determine one or more purchase source return steps for the purchase source.

In some implementations the return steps determination system 130 may determine the purchase source return steps based on an identified return policy that is provided by the purchase source. In some implementations the return steps determination system 130 may determine the purchase source return steps based on a plurality of merchandise return policies for the purchase source (provided by the purchase source and/or other source). The other sources may include, for example, sources that provide product purchase source return steps for multiple purchase sources and/or sources related to shipping services that may provide product packaging and/or shipping related information. In some implementations the purchase source return steps may be extracted from the return policies and/or sources related to returning a product, and stored in the content database 120.

Purchase source return steps may include one or more of customizable steps and non-customizable steps. Customizable steps may include one or more of filling a fillable Return Form, determining a return time for a product, determining an amount of refund, and determining a confirmation of refund. The return steps determination system 130 may customize the customizable steps based on data associated with the user and/or a computing device of the user. Non-customizable steps may include one or more of a step to return a product to a return destination, a step to return a product to an address for the return destination, a step to determine a time period for return eligibility, a step to include purchase receipts, and a step to include product labels. Generating the set of steps may include identifying the purchase source return steps that are customizable, the purchase source return steps that are non-customizable, and/or customizing the purchase source return steps that are customizable.

Some purchase source return steps may be customizable or non-customizable based on a purchase source, a user, and/or a product. For example, purchase source return steps that include shipping related information (e.g., shipping service, shipping costs, shipping labels, shipment tracking, and shipping receipt confirmation) may be customizable or non-customizable. In some implementations the user may not be allowed to choose a shipping service, making the purchase source return step related to the shipping service a non-customizable step. In some implementations the purchase source may provide pre-paid shipping labels that must be utilized to return a product, making the purchase source return step related to the shipping label a non-customizable step. On the other hand, shipping related information may be customizable if the user may select a shipping service, pay for shipping costs, and optionally track a product shipment.

As another example, purchase source return steps that include product packaging may be customizable or non-customizable. In some implementations the purchase source may provide the product packaging required to return a product, making the purchase source return step related to product packaging a non-customizable step. In some implementations the user may need to determine the required product packaging, making the purchase source return step related to product packaging a customizable step.

Also, for example, purchase source return steps that include a return destination may be customizable or non-customizable. In some implementations the return destination may be the same for all products purchased from the purchase source, making the purchase source return step related to identifying a return destination a non-customizable step. In some implementations the return destination may be based on a location of the user, and/or a product attribute, making the purchase source return step related to identifying a return destination a customizable step. For example, the purchase source may be associated with a web-based document that provides the user with a return destination locator based on the user's geographic location. The user may input a postal zip code and the return destination locator may identify one or more return destinations that are within a given distance from the geographical area identified by the postal zip code.

In some implementations a source may not provide the information needed to return a product in the form of a set of purchase source return steps. Instead, the information may be provided in the form of one or more paragraphs and/or other text segments. In such instances, the return steps determination system 130 may determine the purchase source return steps based on the content of the paragraphs and/or other text segments. For example, in some implementations a given sentence in a paragraph may be parsed into more than one purchase source return step. Also, for example, two or more sentences in a paragraph may be merged together to form a purchase source return step.

One or more natural language processing techniques may be optionally utilized to segment a paragraph or other text segment into steps. For example, key terms and/or key phrases may be identified along with their parts of speech. A parse tree may be determined that links key terms and/or phrases in one or more sentences based on their syntactic and/or semantic relationships. In some implementations a context-free grammar may be utilized to structure a sentence from the parse tree. Transitional terms such as “first”, “next”, “followed by”, “after”, “at the outset”, “finally”, etc. may be optionally utilized to segment a paragraph and/or a sentence.

In some implementations a confidence measure may be associated with one or more of the sources related to returning a product. The confidence measure may be utilized to exclude certain sources from being utilized in determining purchase source return steps and/or to weight certain sources more or less heavily in determining purchase source return steps. The confidence measure for a given source of the identified plurality of sources related to returning a product may be indicative of the effectiveness of the given source in providing correct steps to return a product. In some implementations the confidence measure for the given source may be based on the timeliness of the given source. For example, documents may include, or may be associated with, timestamp data indicating the last time the documents were updated and a given document associated with timestamp data indicating recent update may be associated with a confidence measure more indicative of confidence than another document associated with timestamp data that does not indicate recent update.

In some implementations the confidence measure for the given source may be based on the percentage of documents that link to the given source in a given corpus of documents. A larger number and/or percentage of documents linking to the given source may be more indicative of popularity and/or the authoritative value of the given source and the given source may be associated with a confidence measure more indicative of confidence. In some implementations a confidence measure may only be associated with a given source if a threshold number and/or percentage of documents link to the given source. In some implementations the confidence measure for the given source may be based on the number of outgoing links from the given source. A larger number of outgoing links may be indicative of the comprehensiveness of the given source, and the given source may be associated with a confidence measure more indicative of confidence.

Additional and/or alternative techniques may be utilized to determine the confidence measure of a given source. For example, frequency of visits to the given source, one or more existing rankings, and/or one or more user reviews associated with the given source may be utilized in determining the confidence measure of the given source. In some implementations the confidence measure of the given source may be based on one or more entities related to the given source. For example, in some implementations the return steps determination system 130 may identify a brand manufacturer and/or purchase location related to the given source (e.g., if the product is a television by Brand X, is the given source related to the manufacturer of Brand X). The confidence measure associated with the given source that is related to a purchase source of a product may be more indicative of confidence than a confidence measure associated with a source that may not be related to the purchase source of the product.

### Example

### Purchase Source Return Steps

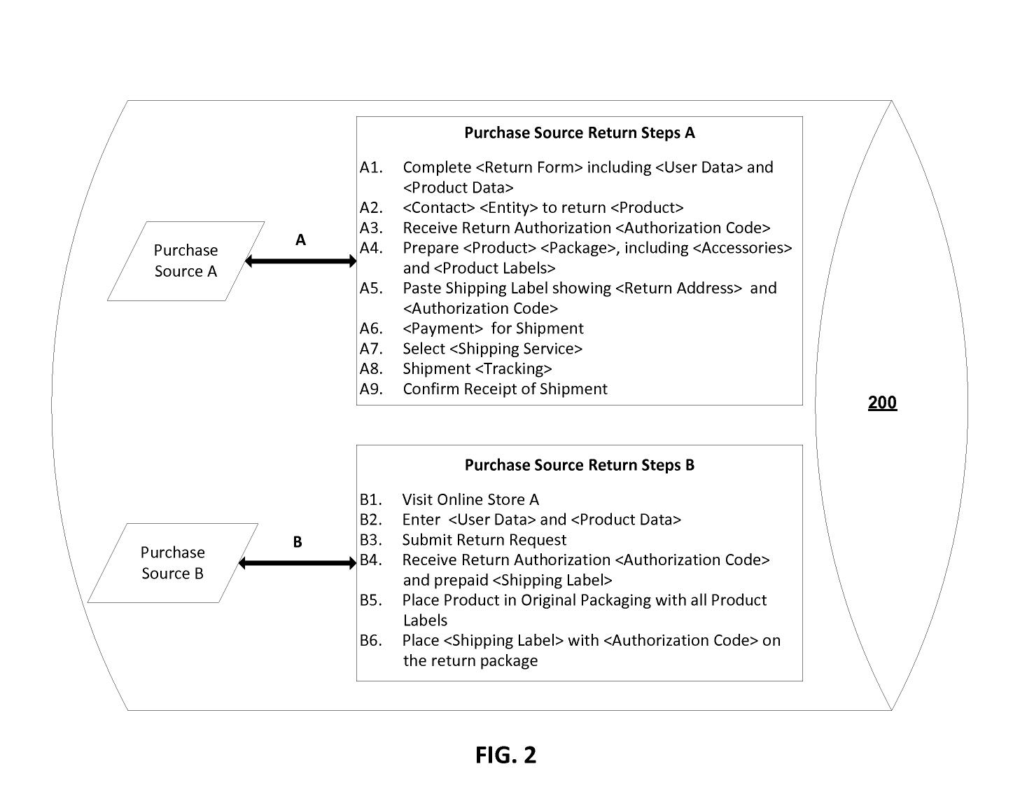

Referring now to FIG. 2, example associations between purchase sources and purchase source return steps in a database are illustrated. A portion 200 of a database is shown. Based on product return indication data the return steps determination system 130 may identify Purchase Source A. Data related to the Purchase Source A may be stored in a database such as content database 120. The data related to the Purchase Source A may be associated with Purchase Source Return Steps A via an association A. Likewise, based on product return indication data the return steps determination system 130 may identify Purchase Source B. Data related to Purchase Source B may be stored in a database such as content database 120. The data related to the Purchase Source B may be associated with Purchase Source Return Steps B via an association B. As illustrated, Purchase Source Return Steps A and Purchase Source Return Steps B may each include one or more steps. The one or more steps may include customizable and non-customizable steps. For purposes of the description herein, any term enclosed within the brackets “< >” will denote a customizable aspect of a purchase source return step.

Purchase Source Return Steps A includes steps A1 through A9. Step A1 states: “Complete Return <Form> including <User Data> and <Product Data>.” The “<Form>, “<User Data>”, and “<Product Data>” are data fields that may be customizable, based at least in part on the data associated with the user. Step A2 states: “<Contact> <Entity> to return <Product>”. The data fields “<Contact>”, “<Entity>”, and “<Product>” are customizable. The data field “<Contact>” refers to one or more forms of contact such as via email, telephone, text, etc. The data field “<Entity>” refers to the email address, telephone number, text message number, etc. associated with the respective forms of contact for the purchase source. Additional steps A3 to A9 are illustrated.

Purchase Source Return Steps B includes steps B1 through B6. Steps B1, B5, and B3 are non-customizable steps. In step B1, the term “Online Store A” may be associated with a hyperlink to a web-based document associated with the purchase source. Steps B2, B4, and B6 may be customizable steps that include one or more customizable data entry fields, such as “<User Data>”, “<Shipping Label>”, etc.

### Return Step Parameters

In some implementations the return steps determination system 130 may utilize return step parameters to generate a set of steps from the purchase source return steps. The return step parameters may identify one or more of product return indication data, data associated with the user, and product data, to customize the customizable data entry fields in the purchase source return steps. For example, data associated with the user may be utilized to customize one or more aspects of the purchase source return steps related to shipping. Data associated with the user may also be utilized to generate one or more steps related to a shipping service (e.g., providing a link to a website, providing directions, and so forth). Also, for example, product data may be utilized to customize one or more aspects of the purchase source return steps related to product packaging and/or insurance. As another example, an identified purchase source may be utilized to customize one or more aspects of the purchase source return steps related to determining a return destination. Also, for example, data associated with the user may be utilized to generate one or more steps related to customized reminder notifications for product return.

In some implementations determining the return step parameters may include determining the return destination of the product. In some implementations the return destination for the product to be returned may be different from the purchase location of the product identified by the product return indication data. For example, the user may purchase a home appliance from a retail store location. However, the home appliance may be required to be returned to the manufacturer for any returns based on product defects. Accordingly, the return destination for the home appliance may be the manufacturer of the home appliance, whereas the purchase location of the home appliance is the retail store location. As another example, the purchase location of a jewelry item may be an online retailer for Jewelry Company Y. However, Jewelry Company Y's return policy may indicate that the jewelry item may only be returned at one of Jewelry Company Y's brick and mortar store locations. Accordingly, the purchase location for the jewelry item is the online retailer for Jewelry Company Y, whereas the return destination for the jewelry item is one of Jewelry Company Y's brick and mortar store locations.

In some implementations the return steps determination system 130 may identify a purchase source return step that states: “Confirm <Product> and <Purchase Source>”. Based on product return indication data, the return steps determination system 130 may customize one or more aspects of the purchase source return steps related to determining a return destination. For example, the return steps determination system 130 may identify the product and the purchase source of the product as “60″ HDTV” and “BrandX Retailer”, respectively. Based on such determination the return steps determination system 130 may determine a return step parameter related to the return destination of the product. For example, the return steps determination system 130 may access the content database 120 to retrieve a return address associated with the return of 60″ HDTVs that are purchased from BrandX Retailer. In some implementations the return steps determination system 130 may generate a step such as: “Please confirm that you are returning a 60″ HDTV that was purchased from BrandX Retailer”, and upon receipt of affirmative user confirmation, may determine a return step parameter related to the return destination of the product.

As another example, the return steps determination system 130 may identify a purchase source return step that states: “Complete <Return Form> including <User Data> and <Product Data>”. The return steps determination system 130 may access the Return Form, including the one or more data entry fields in the Return Form. Based on product return indication data, product data and/or data associated with the user, the return steps determination system 130 may fill in return step parameters related to the one or more data entry fields in the Return Form. In some implementations an auto-fill application may be utilized to complete the Return Form. Based on such return step parameters, the return steps determination system 130 may generate a step such as: “Review Completed Return Form”.

Also, for example, the return steps determination system 130 may identify a purchase source return step that states: “<Contact> <Entity> to return <Product>”. Based on product return indication, the return steps determination system 130 may identify return step parameters related to “<Contact>” and “<Entity>”. For example, a return policy associated with the purchase source may be retrieved from the content database 120, and the return steps determination system 130 may identify “<Contact>” and “<Entity>” as “Email” and “returns@brandx.com” respectively. Based on such return step parameters, the return steps determination system 130 may generate a step such as: “Email Form to returns@brandx.com”.

In some implementations determining the one or more return step parameters may include determining parameters to generate one or more shipping labels. In some implementations the return steps determination system 130 may identify the type of product, a method of shipment, and based at least on such factors, determine the parameters to generate one or more shipping labels. For example, based on the purchase source return steps, the return steps determination system 130 may identify that the deadline to return a product is the next day. The return steps determination system 130 may additionally identify that the user lives in a geographic location where the USPS is the only method of shipment. Additionally and/or alternatively, the return steps determination system 130 may identify the product dimensions. Based at least in part on such factors, the return steps determination system 130 may customize one or more aspects of the purchase source return steps related to generating a shipping label. For example, the return steps determination system 130 may determine that the product may be returned using priority mail express in a “flat rate box” available at USPS. The return steps determination system 130 may generate a shipping label and provide the shipping label to the user. In some implementations the shipping label may be provided along with instructions to visit a nearby USPS location. In some implementations the instructions may include one or more of an address for a nearby USPS location, directions to a USPS location, a telephone number of the USPS location, and a website associated with the USPS location.

In some implementations the return steps determination system 130 may utilize product data to customize one or more aspects of the purchase source return steps related to product packaging. For example, one or more additional shipping labels may be generated to ship the product. Based at least in part on product data, return step parameters related to the product may be determined. For example, the product may be identified as a fragile item, and the return steps determination system 130 may generate a shipping label that identifies the product as being a fragile item. For example, a shipping label such as “FRAGILE—HANDLE WITH CARE” may be generated and provided to the user. As another example, based at least in part on product data, the product may be identified as a home appliance and the return steps determination system 130 may generate a shipping label that identifies the top and bottom portions of the packaging box. For example, a shipping label such as “THIS SIDE UP” may be generated and provided to the user.

In some implementations the return steps determination system 130 may utilize product data to customize one or more aspects of the purchase source return steps related to shipping insurance. For example, the return steps determination system 130 may identify and/or provide return step parameters related to insurance options (e.g., via third party vendors) based on whether the product is a high value product and/or the value of the product to be returned. Such value determination may be based on user input of value and/or product data. For example, a shipping service may offer insurance for products that are valued up to a maximum insured value of $25,000. The return steps determination system 130 may identify one or more of such insurance options. In some implementations associations between products and their insurance options may be stored in a database such as content database 120.

In some implementations products to be returned and/or purchase sources for products to be returned may be associated with the one or more return step parameters and such associations may be stored in a database such as content database 120. Upon receipt of the product return indication data the return steps determination system 130 may identify the product to be returned, access the content database 120 and retrieve the one or more return step parameters associated with the product to be returned. In some implementations the return steps determination system 130 may identify the purchase source of the product to be returned, access the content database 120 and retrieve the one or more return step parameters associated with the purchase source of the product to be returned.

In some implementations the return steps determination system 130 may utilize product data to customize one or more aspects of the purchase source return steps related to product return eligibility. Some products may be ineligible for return upon completion of the purchase transaction. For example, software products that have been removed from their packing, downloaded software materials, gift cards, perishable items, custom-designed merchandise, and so forth may be ineligible for return. In such instances the return steps determination system 130 may identify a product return indication data, identify a product to be returned and determine return step parameters related to eligibility of the product to be returned. For example, a purchase source return step may state: “<Product> < is/is not eligible> for a return”, and the return steps determination system 130 may identify the product to be returned as “60″ HDTV” and may determine a return step parameter related to eligibility for product return. For example, the return steps determination system 130 may determine, based on product data, that the 60″ HDTV was an open-box item that is not eligible for a return. Accordingly, the user may be provided with a step such as: “The 60″ HDTV is not eligible for a return”. In some implementations the return steps determination system 130 may identify and update a list of products that may be ineligible for a return. Such a list of products ineligible for return may be stored in a database such as content database 120.

Certain products that may be eligible for a return may have a limited time period for return from a purchase date. For example, electronic devices may be generally returned within a month from the purchase date. As another example, stores generally have a specified time period within which unused clothing items and accessories may be returned. In some implementations the return steps determination system 130 may access the content database 120 to retrieve information related to eligibility to return a product. In some implementations the return steps determination system 130 may determine a return step parameter related to a time period to return a product. Such determination may be based on the time of purchase, and/or on the time a product return indication data is received. Upon determination of a product and its purchase date, the return steps determination system 130 may, in some implementations, access the content database 120 to determine a time period for full and/or partial refund. For example, data associated with the purchased product may be retrieved from the content database to identify that a return step parameter the product must be returned within 14 days for a full refund. As another example, a return policy associated with the purchase source may be retrieved from the content database to identify a return step parameter that the product must be returned within 14 days for a full refund. Based at least in part on such return step parameters, the return steps determination system 130 may customize the purchase source return steps. For example, a purchase source return step may state: “Confirm <Product> Return based on <Amount of Refund>”, and the return steps determination system 130 may identify the product to be returned as “60″ HDTV” and determine a return step parameter related to the amount of refund as “$2300.00”. Accordingly, the user may be provided with a step such as: “Please confirm that you would like to return the 60″ HDTV for a refund of $2300.00”.

In some implementations the return steps determination system 130 may determine return step parameters related to a time period for product return, and may generate a reminder notification based on such return step parameters. For example, after the product is purchased (e.g., an online purchase via a mobile device), the return steps determination system 130 may provide the user with a message stating: “You have 14 days to return the product for a full refund. Please save the product labels and the receipt.” In some implementations the return steps determination system 130 may create a calendar entry that reminds the user of the product return date. In some implementations the return steps determination system 130 may keep a record of the number of days that have elapsed since the purchase date of the product, and provide reminder notifications to the user at one or more intervals of time. Such intervals may be based on user input. For example, the user may request a reminder to be provided within 48 hours, and again within 24 hours of the return date deadline.

In some implementations the user may request a reminder notification for every product purchased by the user. In such instances the return steps determination system 130 may maintain a list of products purchased by the user (e.g., based on data associated with the user) and respective return step parameters, including return time periods associated with each product in the list of products. Reminder notifications for each product in the list of products may be generated and provided to the user. In some implementations the user may select one or more of the products in the list of products and request reminder notifications for the selected products. In some implementations the return steps determination system 130 may provide the user with a selectable option to receive reminder notifications for a product. In some implementations such a selectable option may be provided at the time of purchase based on data associated with the user. In some implementations such a selectable option may be provided at the time a product return indication data is received.

In some implementations the user may be wearing a wearable computing device when the product is purchased and/or returned. A real-time image processing system and/or other components of the wearable computing device may identify a purchase source, product data, characteristics of the product, and/or attributes of the user. For example, the wearable device may identify one or more user activities such as entering a purchase location, selecting a product, approaching a cashier, paying for the product, approaching a product return location, and so forth. The wearable device may capture an image of the product, its model number, and/or product bar code. The wearable device may additionally and/or alternatively capture payment activity of the user, such as whether the user paid in cash, used a store credit, and/or a credit card. A record of the one or more user activities may be maintained and such record may be associated with timestamp data indicating the purchase date of the product. Such record may be securely stored in a private database associated with the user. The return steps determination system 130 may determine a time period to return a product for the purchased product from such record. The return steps determination system 130 may generate one or more reminder notifications based on the time period to return a product for the product.

### Generating a Set of Steps

A set of steps to return the product may be generated based on the purchase source return steps. As described herein, one or more steps of the purchase source return steps may include data fields that are customizable. Return step parameters may be identified to customize the customizable data fields to generate customized purchase source return steps. A set of steps may be generated based on the customized purchase source return steps and any non-customizable purchase source return steps. In some implementations the purchase source return steps may be identified as the generated set of steps. In some implementations one or more of the purchase source return steps may be combined to generate a step of the set of steps. In some implementations additional data associated with the user, such as attributes of the user, may be utilized to generate one or more steps of the set of steps.

In some implementations generating the set of steps to return the product may include determining a sequential order of the set of steps. In some implementations the order of the steps in the set of steps may be based on an existing arrangement of steps in one or more sources from which the steps are retrieved. In some implementations the arrangement may be determined based on the order of appearance of the steps in text segments, and/or the order of appearance of the text segments in a document from which the steps may be extracted. Additionally and/or alternatively the arrangement of the steps in the set of steps may be determined based on transition terms such as “first”, “next”, “followed by” and “lastly”.

In some implementations the scoring system 135 may determine a quality measure for a generated set of steps to return a product. The quality measure is indicative of quality of the generated set of steps provided in response to a product return indication data based on user feedback. In some implementations the quality measure may be based on a number of users viewing the generated set of steps provided in response to a product return indication data, a number of sites linking to the generated set of steps, user reviews, and/or user ratings. One or more techniques may optionally be combined to determine the quality measure. In some implementations a threshold value may be determined and the quality measure of a generated set of steps provided in response to a query may be compared to the threshold value.

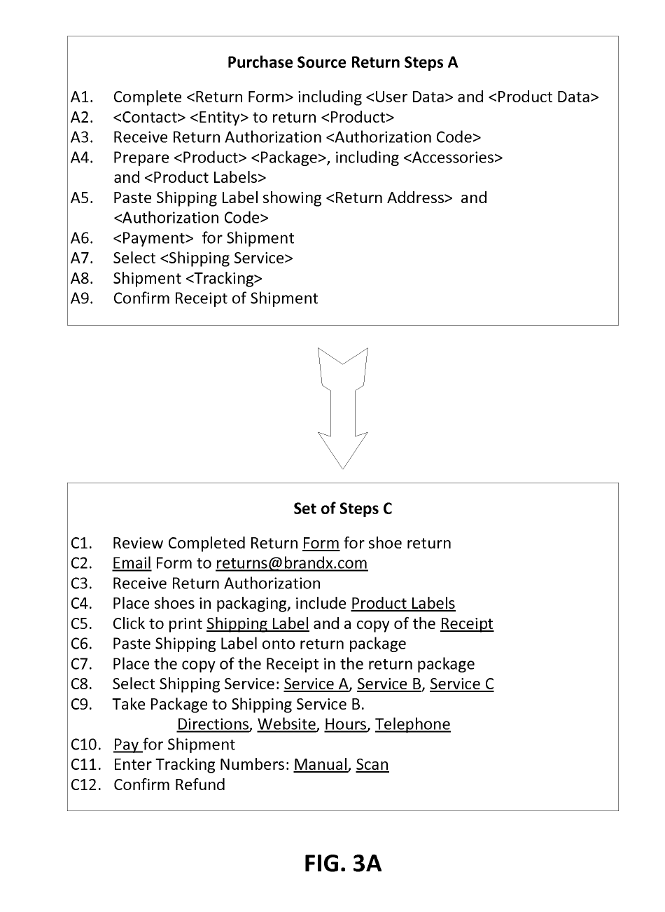

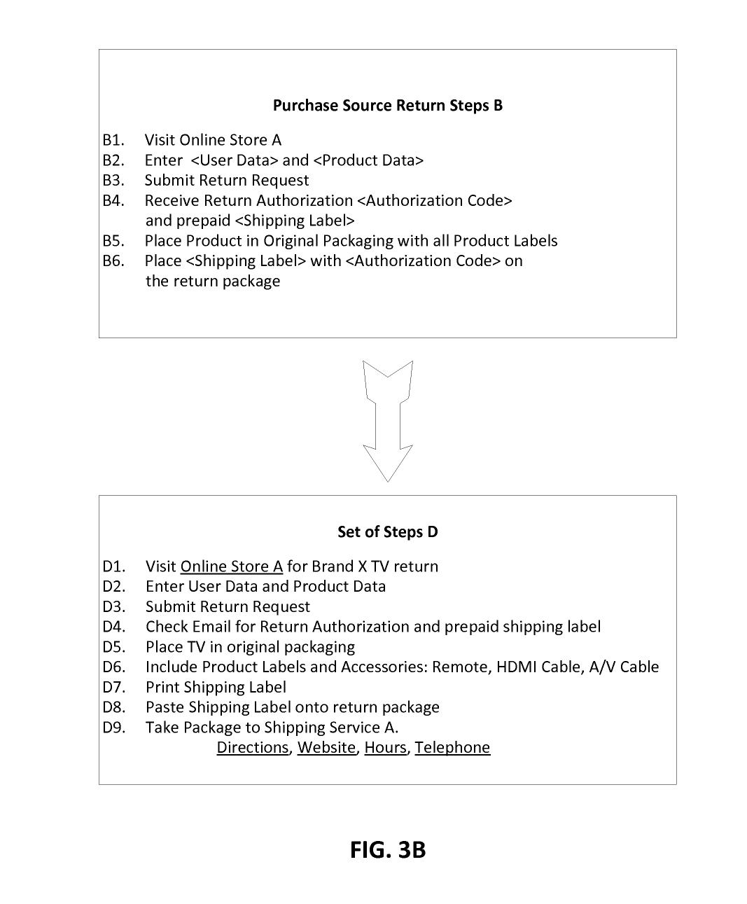

Referring now to FIG. 3A, generating an example set of steps based on purchase source return steps is illustrated. Example Purchase Source Return Steps A may be utilized as a template to generate an associated Set of Steps C. For example, the return steps determination system 130 may identify a desire of the user to return a pair of shoes, and also identify a purchase source for the pair of shoes. As described herein, the return steps determination system 130 may access content database 120 to retrieve Purchase Source Return Steps A. Product return indication data and/or data associated with the user may be utilized to identify product data and user data. Based on the product data and the user data, return step parameters associated with the purchase source return steps A may be identified to customize the customizable steps of the Purchase Source Return Steps A.

For example, the return steps determination system 130 may utilize data associated with the user, and an auto-fill application, to complete the Return Form indicated in Step A1. Accordingly, Step C1 in the set of steps C may be a step to “Review Completed Return Form for shoe return”. In some implementations the term “Form” may be hyperlinked to the completed form, and the user may select the hyperlinked term to access, complete, and/or review the return form.

As another example, the return steps determination system 130 may determine return step parameters to identify the terms “<Contact>” and “<Entity>” in step A2 to mean “Email” and “returns a brandx.com”. Accordingly, step C2 may state: “Email Form to returns@brandx.com”. Also, for example, Step C5 may state: “Click to print Shipping Label and a copy of the Receipt,” with selectable options to click the term “Shipping Label” and/or the term “Receipt”. In some implementations the return steps determination system 130 may prompt the user to include a copy of the receipt to be included in the shipment. In some implementations the return steps determination system 130 may utilize data associated with the user to identify a receipt for the product to be returned. For example, the user may have received confirmation of the purchase of the product via email, and a copy of the receipt may have been included with that email. The return steps determination system 130 may retrieve the receipt from the email communication and provide it to the user. As another example, the user may have purchased the product at an online store. The return steps determination system 130, based on user authorization, may have saved a record of that transaction. In some implementations such a record may be saved in a private database associated with the user. Upon receiving the product return indication data, the return steps determination system 130 may retrieve the transaction record from the database associated with the user, generate a receipt, and/or provide such receipt to the user for inclusion in a product return packaging.

Step C6 states: “Paste Shipping Label onto return package.” In some implementations the return steps determination system 130 may generate a shipping label with the return address based on return step parameters, and provide the label to the user. In some implementations the purchase source may provide a pre-paid shipping label, and the return steps determination system 130 may retrieve the pre-paid shipping label and provide it to the user. In some implementations the pre-paid shipping label may include a digital code (e.g., a QR code) based on the product to be returned. For example, a product return indication data may include a bar code for the product to be returned. In some implementations the bar code may be manually input by the user, or the bar code may be scanned by an optically scanning device, or the bar code may be extracted from an image of the product to be returned. The return steps determination system 130 may provide the bar code to the purchase source via a digital interface. In some implementations the digital interface at the purchase source may provide a shipping label that may optionally incorporate data extracted from the digital bar code.

Also, for example, the return steps determination system 130 may determine one or more shipping services based on return step parameters, and provide these to the user as indicated by step C8. Step C8 states: “Select shipping service: Service A, Service B, Service C.” In some implementations the purchase source may specify the use of a shipping service. Step A7 may then be identified as a purchase source return step that is non-customizable. On the other hand, in some implementations, the choice of the shipping service may be based on the user's geographic location, the number of days within which the product may need to be returned, etc. In such instances, Step A7 may be identified as a purchase source return step that is customizable. For example, the return policy may state that the product must be received at the purchase source within 14 days of purchase. Based on one or more criteria described herein, the return steps determination system 130 may determine that 13 days have already passed since the purchase date of the product. Based on such determination the return steps determination system 130 may identify a shipping service that provides overnight delivery of the product to be returned. In some implementations the user may indicate a preference for Shipping Service B. Accordingly, Shipping Service B may be presented to the user as step C9, along with selectable options for “Directions” to Shipping Service B, a “Website” for Shipping Service B, the “hours” of operation for “Shipping Service B”, and a “telephone” number for Shipping Service B. In some implementations step C8 may precede step C5. In some implementations the “Shipping Label” in step C5 may include a return address, but may not be based on a selection of a shipping service. In such instances, step C5 may precede step C8.

Additionally, and/or alternatively, step C8 may state: “Arrange for shipping.” Based on the method of shipment, the return steps determination system 130 may identify a shipping service and schedule a pick-up or drop-off location and/or time. For example, based on user data, the return steps determination system 130 may determine that the user prefers to drop the package off at the nearest USPS location. The return steps determination system 130 may provide directions to the nearest USPS location, and/or the hours of operation of the USPS location. As another example, based on user data, the return steps determination system 130 may determine that the user prefers the package to be picked up from a given address (e.g., a residential address, a work address). Accordingly, the return steps determination system 130 may schedule a pick-up of the package from the appropriate location. In some implementations the return steps determination system 130 may prompt the user for confirmation before scheduling any such pick-up and/or drop-off locations.

In some implementations the return steps determination system 130 may additionally track the shipment. For example, the user may be presented a step C11 that provides the user with an option to manually enter a tracking number, and/or scan a tracking number from a mailing receipt. In some implementations the return steps determination system 130 may track the shipment and confirm receipt. Based on such confirmation, the user may be presented with a step C12 to “Confirm Refund”.

In some implementations the return steps determination system 130 may additionally and/or alternatively provide a reminder notification to the user after seven days of receipt to check whether the refund has been credited to the credit card. In some implementations the user may provide access to the user's online credit card account, and the return steps determination system 130 may automatically determine if a transaction indicative of a refund has appeared on the user's credit card account. Also, for example, upon determining that a refund has not been received after seven days of receipt of the returned product, the return steps determination system 130 may prompt the user to contact the purchase source. In such instances, the return steps determination system 130 may provide the user with contact information (e.g., a telephone number and/or an email) for contacting the purchase source. In some implementations the return steps determination system 130 may automatically send a reminder message to the purchase source requesting refund for the returned product.

In some implementations the set of steps may be provided at the same time. In some implementations the set of steps may be provided at different times. For example, steps C1 and C2 may be provided at one time. Upon completion of steps C1 and C2, the return steps determination system 130 may access identifiers associated with, for example, an email application in a mobile device of the user, to determine that a return authorization has been approved. Steps C3, C4, C5, C6, and C7 may then be provided to the user. In some implementations the user may choose not to complete step C10 on a given day. The return steps determination system 130 may provide one or more reminder notifications to the user, and based on an affirmative user indication, may provide step C9 to the user. Steps C10 and C11 may be provided at the time the product is shipped. In some implementations the return steps determination system 130 may track the return shipment to confirm receipt of the shipment. The user may be provided with step C12 after receipt of the shipment has been confirmed.

Referring now to FIG. 3B, another example of generating a set of steps based on purchase source return steps is illustrated. Example Purchase Source Return Steps B may be utilized as a template to determine an associated Set of Steps D. For example, the return steps determination system 130 may identify a desire of the user to return a Brand X television, and also identify a purchase source for the television. As described herein, the return steps determination system 130 may access content database 120 to retrieve Purchase Source Return Steps B. Data associated with the user may be utilized to identify product data and user data. Based on the product data and the user data, return step parameters associated with the purchase source return steps B may be identified to customize the customizable steps of the Purchase Source Return Steps B.

In some implementations step D1 provides the user with a web link to “Online Store A”. Step D2 prompts the user to enter user data and product data. In some implementations the return steps determination system 130 may identify return step parameters related to the user data and the product data. Step D3 prompts the user to submit a return request. In some implementations steps D1, D2, and D3 may be performed automatically without user input. In some implementations a return authorization and prepaid shipping label may be sent to the user via email in response to the submission of the return request. Step D4 prompts the user to retrieve the return authorization and prepaid shipping label from the email. Step D5 prompts the user to place the television in its original packaging. In some implementations the return steps determination system 130 may access content database 120 to retrieve return step parameters related to a list of product labels and accessories (e.g., remote, HDMI cable, A/V cable) that may be generally shipped with the television set. The user may be provided with this list. Step D6 prompts the user to include all product labels and accessories. In some implementations the user may be provided with a selectable list, based on the return step parameters, and the user may be prompted to confirm that each accessory has been included in the product packaging. In some implementations the return steps determination system 130 may identify a purchase source return step “A5. Paste Shipping Label showing <Return Address> and <Authorization Code>” and identify one or more return step parameters related to determining a shipping service and/or shipping labels. Based on such return step parameters, the return steps determination system 130 may provide Step D7 to prompt the user to print a shipping label and provide step D8 to prompt the user to affix the shipping label onto the return package. As described herein, the purchase source return step related to a shipping service may be a non-customizable step, and the shipping service (e.g., Shipping Service A) may be determined based on the purchase source. Step D9 prompts the user to take the return package to Shipping Service A, along with selectable options for “Directions” to Shipping Service A, a “Website” for Shipping Service A, the “hours” of operation for Shipping Service A, and a “telephone” number for Shipping Service A.

### Providing the Set of Steps to a User

The set of steps to return the product may be provided to the user. In some implementations a generated set of steps may be provided in response to a product return indication data based on its product return indication score. For example, a generated set of steps may be provided in response to a product return indication data if that product return indication data is associated with a product return indication score that satisfies a threshold product return indication score. The threshold product return indication score may be indicative of sufficient confidence that the product return indication data indicates a desire to return a product indicated by the product return indication data. The return steps determination system 130 may access content database 120 to identify the associated generated set of steps and provide such steps in response to the product return indication data.

As described herein, in some implementations the set of steps may be provided at the same time, or at different times. For example, the set of steps may be provided at the time a product is purchased. As another example, the set of steps may be provided when the user searches for information on how to return a product, and additional data associated with the user is indicative of the user having purchased a product within a threshold of time of issuing the search query.

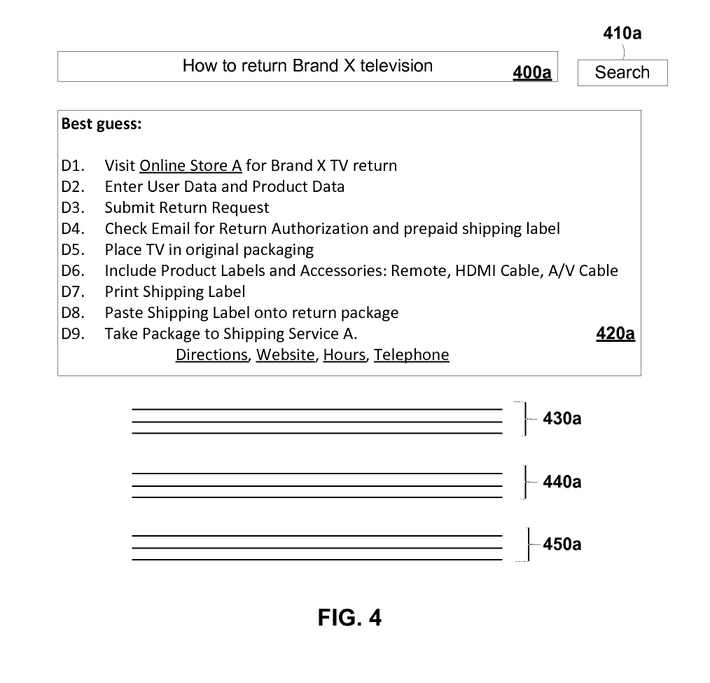

Referring to FIG. 4, an example graphical user interface for providing a generated set of steps to return a product is shown. The user may input a query “How to return Brand X television” into a user-editable field such as search box 400a and issue a search by selecting a search icon 410a. The search system 140 receives the query and provides the query to the return steps determination system 130. The return steps determination system 130 may access content database 120 to retrieve a generated set of steps to return a Brand X Television. In some implementations the generated set of steps may be displayed in a highlighted form, for example, in display box 420a. In some implementations the set of steps may be displayed with a heading such as “Best Guess” indicating a medium level of confidence in the generated set of steps. In some implementations the set of steps may be displayed with a heading such as “Authoritative Steps” indicating a high level of confidence in the generated set of steps. Additional and/or alternative indicators of confidence may accompany the set of steps.

In some implementations display box 420a may also include one or more attributes such as a listing of the sources of the information, “From: Product Source A, Product Source B, and 3 others.” Hyperlinks to such sources may optionally be provided. In some implementations the one or more attributes may be provided with an indicator of confidence as described herein (e.g., the sources may each be provided with an indicator indicative of the respective confidence measure). Additional search results may follow such as first search result 430a, second search result 440a, and third search result 450a.

One or more techniques described herein to determine the confidence measure of a given source, product return indication score, and/or quality measure may be optionally combined. For example, a linear combination of the one or more confidence measures described herein may be utilized to associate a confidence measure with the given source. As another example, a weighted average of the one or more product return indication scores described herein may be utilized to associate a product return indication score with a given product return indication data. Weighting may be based on, for example, one or more of the product identified by the product return indication data, the given purchase source, and one or more users.

The content database 120, the return steps determination system 130, the scoring system 135, and/or the search system 140 may be implemented in hardware, firmware, and/or software running on hardware. For example, one or more of the systems may be implemented in one or more computer servers. Many other configurations are possible having more or fewer components than the environment shown in FIG. 1. For example, in some environments the return steps determination system 130 may include a scoring system 135. In some environments the return steps determination system 130 and the scoring system 135 may be separate components.

### Example Method of Determining a Set of Steps

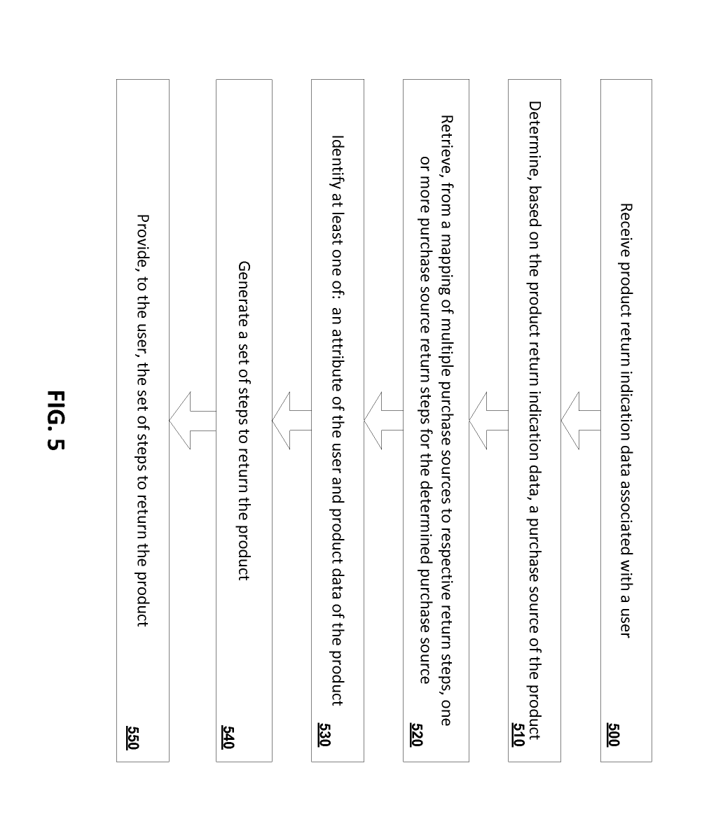

Referring to FIG. 5, a flow chart illustrates an example method of generating a set of steps to return a product. Other implementations may perform the steps in a different order, omit certain steps, and/or perform different and/or additional steps than those illustrated in FIG. 5. For convenience, aspects of FIG. 5 will be described with reference to a system of one or more computers that perform the process. The system may include, for example, the return steps determination system 130 of FIG. 1.

At step 500, product return indication data associated with a user may be received. The return steps determination system 130 may receive a user identification identifying a user, and product return indication data that is associated with the user and that indicates a desire of the user to return a product. In some implementations the received user identification and/or the received product return indication data may be based on information provided from the client device 110 and/or one or more additional computing devices of the user.

For example, after receiving a pair of shoes, the user may place a telephone call, via the client device 110, to the customer service department of the store from where the pair of shoes was purchased. The telephone number may be provided to the return steps determination system 130 by the client device 110. The return steps determination system 130 may access a database, such as content database 120, to determine an association between the telephone number called and one or more indications that the telephone number relates to a product return. For example, the database may include an association between the telephone number and data that explicitly identifies the telephone number as related to a product return. Also, for example, the database may include an association between the telephone number and the text “customer service department”, and the return steps determination system 130 may determine the telephone number is associated with product return based on the text “customer service department”.

Product return indication data based on multiple user actions and/or locational data may optionally be combined to determine a desire of a user to return a product. For example, electronic communications of a user (e.g., a purchase confirmation e-mail sent to the user) may indicate that the user may have purchased a product, and the user's navigation history may indicate that the user is seeking information related to returning the product. As another example, financial activity of the user may indicate that the user may have purchased a product and a post on a social networking site may indicate user's desire to return the product. As yet another example, a social networking post, navigation history, and a locational query may all indicate a desire of a user to return a product. A combination of one or more such user actions may indicate that user is seeking information related to returning the product. Based at least in part on product return indication data from such multiple user actions, the return steps determination system 130 may determine a desire of a user to return a product.

In some implementations the scoring system 135 may determine a product return indication score based on the product return indication data received by the return steps determination system 130. The product return indication score is indicative of the strength of the desire of the user to return a product associated with the product return indication data.

At step 510, a purchase source of the product may be determined based on the product return indication data. In some implementations the return steps determination system 130 may determine the purchase source of the product based on the product return indication data and/or additional data associated with a user. A purchase source may be a manufacturer, a retailer, a brick and mortar location, an online store, an individual, and so forth. In some implementations, the determined purchase source may be a source that has multiple venues for purchasing the product. For example, the determined purchase source may be a brick and mortar retail chain that has multiple individual stores in which the product may have been purchased and/or one or more online stores from which the product may have been purchased. Also, for example, the determined purchase source may be an online retailer that has multiple affiliated websites from which the product may have been purchased. In some implementations the determined purchase source may be a particular venue. For example, the determined purchase source may be an individual store of a brick and mortar retail chain.

For example, the product return indication data may include data based on an e-mail confirming a previous purchase of the user of a pair of shoes from Retailer 1 and data based on a query of “how do I return the pair of shoes I purchased”. Based on an association of the query with the pair of shoes and an association of the e-mail with the pair of shoes, the return steps determination system 130 may utilize the “Retailer 1” in the e-mail as the purchase source.

At step 520, one or more sets of purchase source return steps of the determined purchase source may be retrieved. The return steps determination system 130 may retrieve one or more purchase source return steps of the determined purchase source. The one or more purchase source return steps may be retrieved from a mapping of multiple purchase sources to respective return steps. For example, the content database 120 may include identifiers of multiple purchase sources and, for each purchase source, one or more purchase source return steps. As one example, the return steps determination system 130 may determine the purchase source as Online Store Y and the content database 120 may include data associating an identifier of Online Store Y with one or more purchase source return steps. The return steps determination system 130 may access the content database 120 and retrieve the one or more purchase source return steps.

Purchase source return steps may include one or more of customizable steps and non-customizable steps. Customizable steps may include one or more of filling a fillable Return Form, determining a return time for a product, determining an amount of refund, and determining a confirmation of refund. The return steps determination system 130 may customize the customizable steps based on data associated with the user. Non-customizable steps may include one or more of a return destination, an address for the return destination, a telephone number for the return destination, a time period for return eligibility, purchase receipts, and product labels.

Some purchase source return steps may be customizable or non-customizable based on a purchase source, a user and/or a product. For example, purchase source return steps that include shipping related information (e.g., shipping service, shipping costs, shipping labels, shipment tracking, and shipping receipt confirmation) may be customizable or non-customizable. For example, the purchase source may identify a shipping service that must be utilized to return a product. As another example, the purchase source may provide shipping labels, optionally including a pre-paid shipping label that must be utilized to return a product. On the other hand, shipping related information may be customizable if the user may select a shipping service, pay for shipping costs, and optionally track a product shipment.

At step 530, at least one of an attribute of the user and product data of the product may be identified. In some implementations the return steps determination system 130 may determine product data based on the product return indication data and/or additional data associated with a user. Product data identifies one or more characteristics of one or more products associated with the product return indication data. Product data for a product may include, for example, one or more of: an alias of the product; a brand of the product; a coded identifier of the product (e.g., a barcode, a serial number, a product code, an inventory code); a type of the product (e.g., glassware, electronics, laptop, perishable, fragile, high value, clothing, book, and/or toy); weight information of the product (e.g., a specific weight, a weight range (e.g., 5-10 lbs.), a weight category (e.g., light, medium, heavy)); and/or dimension information of the product (e.g., a specific dimension, a dimension range, a dimension category).

In some implementations an attribute of the user may be identified. In some implementations the attribute of the user may include user preference to utilize shipping services at a preferred location. For example, the user may prefer to drop the package off at the nearest USPS location. As another example, the user may prefer that the package be picked up from a given address (e.g., a residential address, a work address). The attribute of the user may also include a preferred mode of payment by the user. For example, the user may prefer to make online purchases with a specific credit card. In some implementations, based on user authorization, the return steps determination system 130 may identify data related to the user and/or the credit card and store such data in a private database associated with the user.

At step 540, a set of steps to return the product may be generated. Generating the set of steps may include identifying the purchase source return steps that are customizable, the purchase source return steps that are non-customizable, and/or customizing the purchase source return steps that are customizable. As described herein, one or more steps of the purchase source return steps may include data fields that are customizable. Return step parameters may be identified to customize the customizable data fields to generate customized purchase source return steps. A set of steps may be generated based on the customized purchase source return steps and non-customizable purchase source return steps. In some implementations the purchase source return steps may be identified as the generated set of steps. In some implementations one or more of the purchase source return steps may be combined to generate a step of the set of steps. In some implementations additional data associated with the user, such as attributes of the user, may be utilized to generate one or more steps of the set of steps.

In some implementations the return steps determination system 130 may utilize return step parameters to generate a set of steps from the purchase source return steps. The return step parameters may identify one or more of product return indication data, data associated with the user, and product data, to customize the customizable data entry fields in the purchase source return steps. For example, data associated with the user may be utilized to customize one or more aspects of the purchase source return steps related to shipping. Data associated with the user may also be utilized to generate one or more steps related to a shipping service (e.g., providing a link to a website, providing directions, and so forth). Also, for example, product data may be utilized to customize one or more aspects of the purchase source return steps related to product packaging and/or insurance. As another example, an identified purchase source may be utilized to customize one or more aspects of the purchase source return steps related to determining a return destination. Also, for example, data associated with the user may be utilized to generate one or more steps related to customized reminder notifications for product return.

In some implementations determining the one or more return step parameters may include determining parameters to generate one or more shipping labels. In some implementations the return steps determination system 130 may identify the type of product, a method of shipment, and based at least on such factors, determine the parameters to generate one or more shipping labels. For example, based on the purchase source return steps, the return steps determination system 130 may identify that the deadline to return a product is the next day. The return steps determination system 130 may additionally identify that the user lives in a geographic location where the USPS is the only method of shipment. Additionally and/or alternatively, the return steps determination system 130 may identify the product dimensions. Based at least in part on such factors, the return steps determination system 130 may customize one or more aspects of the purchase source return steps related to generating a shipping label. For example, the return steps determination system 130 may determine that the product may be returned using priority mail express in a “flat rate box” available at USPS. The return steps determination system 130 may generate a shipping label and provide the shipping label to the user. In some implementations the shipping label may be provided along with instructions to visit a nearby USPS location. In some implementations the instructions may include one or more of an address for a nearby USPS location, directions to a USPS location, a telephone number of the USPS location, and a website associated with the USPS location.

At step 560, the set of steps to return the product may be provided to the user. In some implementations a generated set of steps may be provided in response to a product return indication data based on its product return indication score. For example, a generated set of steps may be provided in response to a product return indication data if that product return indication data is associated with a product return indication score that satisfies a threshold product return indication score. The threshold product return indication score may be indicative of sufficient confidence that the product return indication data indicates a desire to return a product indicated by the product return indication data. The return steps determination system 130 may access content database 120 to identify the associated generated set of steps and provide such steps in response to the product return indication data.

### Example Computer System

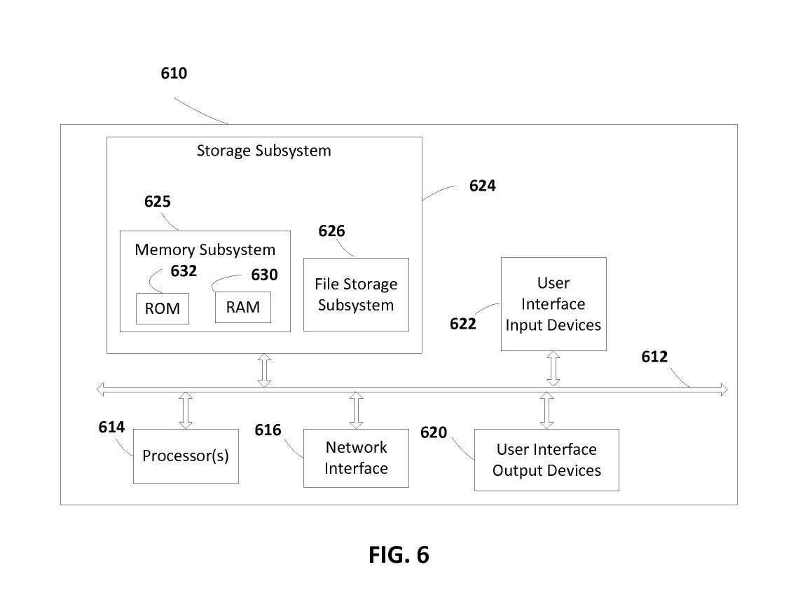

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface input devices 622, user interface output devices 620, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to identify customizable and non-customizable steps of the purchase source return steps. As another example, the storage subsystem 624 may include the logic to determine the set of steps based on the purchase source return steps.

These software modules are generally executed by processor 614 alone or in combination with other processors. Memory 625 used in the storage subsystem can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be optionally stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
receiving product return indication data associated with a user, the product return indication data indicating a desire of the user to return a product;
determining, based on the product return indication data, a purchase source of the product;
retrieving, from a mapping of multiple purchase sources to respective return steps, one or more purchase source return steps for the determined purchase source;
identifying at least one of: an attribute of the user and product data of the product, the identifying based on one or more of the product return indication data and additional data associated with the user;
generating a set of steps to return the product, wherein generating the set of steps is based on the purchase source return steps and based on at least one of: the attribute of the user and the product data of the product; and
providing, to the user, the set of steps to return the product.

2. The method of claim 1, further comprising:
determining a product return indication score based on the product return indication data, the product return indication score indicative of a strength of the desire of the user to return the product;
wherein providing the set of steps to return the product is dependent on the product return indication score.

3. The method of claim 2, wherein the product return indication data includes data related to one or more user actions that are associated with the product; and wherein the product return indication score is based on the one or more user actions.

4. The method of claim 3, wherein the user actions include one or more of a check-in of the user, a payment of the user, an electronic communication of the user, a search query of the user, and navigation to one or more documents by the user.

5. The method of claim 2, wherein a presentation prominence of the set of steps in providing the set of steps to return the product is dependent on the product return indication score.

6. The method of claim 2, wherein providing the set of steps to return the product occurs only when the product return indication score satisfies a threshold.

7. The method of claim 1, wherein one or more of the retrieved purchase source return steps are identified as customizable purchase source return steps and one or more of the purchase source return steps are identified as fixed purchase source return steps; and wherein generating the set of steps is based on at least one of: the attribute of the user and the product data of the product, and wherein generating the set of steps is for only the purchase source return steps that are identified as customizable.

8. The method of claim 1, wherein generating the set of steps includes determining a shipping service for one or more steps of the set of steps to return the product, wherein determining the shipping service is based on the attribute of the user.

9. The method of claim 8, wherein the attribute of the user includes at least one of a geographic location of the user and a shipping preference of the user, and wherein determining the shipping service is based on at least one of the geographic location and the shipping preference.

10. The method of claim 1, wherein generating the set of steps includes determining one or more shipping materials for one or more steps of the set of steps to return the product, wherein determining the shipping materials is based on the product data of the product.

11. The method of claim 10, wherein the product data includes at least one category of the product, and wherein determining the shipping material is based on the at least one category of the product.

12. The method of claim 1, further comprising determining a time period for return of the product.

13. The method of claim 12, wherein a presentation prominence of the set of steps in providing the set of steps to return the product is dependent on the time period for return of the product.

14. The method of claim 1, wherein determining the purchase source of the product is further based on the product data of the product.

15. The method of claim 1, wherein generating the set of steps is based on both the attribute of the user and the product data of the product.

16. A system including memory and one or more processors operable to execute instructions stored in the memory, comprising instructions to:
receive product return indication data associated with a user, the product return indication data indicating a desire of the user to return a product;
determine, based on the product return indication data, a purchase source of the product;
retrieve, from a mapping of multiple purchase sources to respective return steps, one or more purchase source return steps for the determined purchase source;
identify at least one of: an attribute of the user and product data of the product, the identifying based on one or more of the product return indication data and additional data associated with the user;
generate a set of steps to return the product, wherein generating the set of steps is based on the purchase source return steps and based on at least one of: the attribute of the user and the product data of the product; and
provide, to the user, the set of steps to return the product.

17. The system of claim 16, wherein the instructions further include instructions to:
determine a product return indication score based on the product return indication data, the product return indication score indicative of a strength of the desire of the user to return the product;
wherein providing the set of steps to return the product is dependent on the product return indication score.

18. The system of claim 17, wherein the product return indication data includes data related to one or more user actions that are associated with the product; and wherein the product return indication score is based on the one or more user actions.

19. The system of claim 17, wherein a presentation prominence of the set of steps in providing the set of steps to return the product is dependent on the product return indication score.

20. The system of claim 17, wherein providing the set of steps to return the product occurs only when the product return indication score satisfies a threshold.

21. The system of claim 16, wherein generating the set of steps is based on both the attribute of the user and the product data of the product.

22. A non-transitory computer readable storage medium storing at least one program configured for execution by at least one processor of a computer system, the at least one program comprising instructions to:
receive product return indication data associated with a user, the product return indication data indicating a desire of the user to return a product;
determine, based on the product return indication data, a purchase source of the product;
retrieve, from a mapping of multiple purchase sources to respective return steps, one or more purchase source return steps for the determined purchase source;
identify at least one of: an attribute of the user and product data of the product, the identifying based on one or more of the product return indication data and additional data associated with the user;
generate a set of steps to return the product, wherein generating the set of steps is based on the purchase source return steps and based on at least one of: the attribute of the user and the product data of the product; and
provide, to the user, the set of steps to return the product.
